(19) United States
(12) Patent Application Publication
(10) Pub. No.: US 2018/0046975 A1
(43) Pub. Date: Feb. 15, 2018

(54) SENSOR-BASED ITEM MANAGEMENT TOOL

(71) Applicant: Wal-Mart Stores, Inc., Bentonville, AR (US)

(72) Inventors: Nicholaus Adam Jones, Fayetteville, AR (US); Steven Jackson Lewis, Bentonville, AR (US); Matthew Dwain Biermann, Fayetteville, AR (US)

(21) Appl. No.: 15/668,240

(22) Filed: Aug. 3, 2017

Related U.S. Application Data
(60) Provisional application No. 62/373,911, filed on Aug. 11, 2016.

(51) Int. Cl. G06Q 10/08; G01N 21/88; G06Q 20/20

(52) U.S. Cl. CPC G06Q 10/087; G06Q 20/203; G01N 21/88

(57) ABSTRACT

Examples of the disclosure provide a system and method for determining item viability based upon profiles as items are moved in inventory environments. The system receives sensor data, identifies possible candidate items corresponding to the sensor data, determines if any of the candidate items is a match to the profile of the sensor data, and executes a protocol based upon the match.

### BACKGROUND

Many inventory environments contain items which may be removed from the inventory environment, but then replaced. As an example, a consumer examines an item and finds it to be undesirable for some reason, and consequently replaces the item. As consumers repeatedly replace unwanted items, taking undamaged or preferred items, a collection of less desirable items might accumulate. Customers and inventory environment managers are both frustrated by the aggregation of less desirable items, and the repeated evaluation of the undesirable items.

### SUMMARY

Examples of the disclosure provide a method and system for determining item viability based upon the profiles of various items as they are moved in the inventory environment. The system utilizes a plurality of sensors distributed throughout the inventory environment to detect data and transmit sensor data to a processor connected via a communication network. The sensor data includes the detected data and individual sensor identifiers. An item management module, implemented on the processor, receives the sensor data and identifies a plurality of candidate items which are associated with the location that corresponds to the sensor identifier. The item management module compares the detected data to a plurality of stored profiles corresponding to the candidate items. Upon determining that there is a match between the detected data and at least one stored profile, the item management module executes a protocol associated with the stored profile.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for determining item viability based upon detected profiles.

FIG. 2 is an exemplary inventory environment illustrating a possible configuration of sensors and items.

FIG. 3 is an is an alternative exemplary inventory environment illustrating another possible configuration of sensors and items.

FIG. 4 is an exemplary flow chart illustrating operation of the system to evaluate a detected profile for an item and execute an associated protocol.

FIG. 5 is an exemplary flow chart illustrating operation of a machine learning component of the system to evaluate detected profiles and update the machine learning model.

FIG. 6 is an exemplary flow chart illustrating operation of the system to correlate external data, such as reports from an item tracking system, with the detected profiles and to create reports based upon the correlated data.

FIG. 7 is an exemplary data flowchart illustrating interactions between the activity in the inventory environment, profiles detected by the plurality of sensors, and the inventory management system.

FIG. 8 is an exemplary system for implementing various aspects of the disclosure which include a general purpose computing device in the form of a computer.

Corresponding reference characters indicate corresponding parts throughout the drawings.

### DETAILED DESCRIPTION

Referring to the figures, examples of the disclosure leverage machine learning to determine item viability based upon profiles as items are moved in inventory environments. As used herein, an item may refer to a product, object, article, or good. Inventory environment may refer to an environment where items are stored for a time, and may include sub-environments, such as displays, racks, aisles, sections, areas, bins, units, or any other suitable storage environment. Although a retail environment is described for illustrative purposes, aspects of the disclosure are not limited to a retail or business environment.

Aspects of the disclosure allow for the integration of data from various sources, including a plurality of sensors in the inventory environment, to identify and detect item movement within the inventory environment in order to manage item inventory. As an example, transaction data from a transaction system may be correlated with activity detected by the plurality of sensors to provide a feedback loop that may improve a machine learning model used to identify items and associated actions with detected data. In an alternative example, other external data is included in the analysis. For instance, information provided by a manufacturer or distributor, stored or dynamic inventory management information, item specifications, and the like may be integrated into the machine learning model. The machine learning model then identifies or generates a protocol associated with the analysis. In some examples, an alert is generated that corresponds to the detected activity and item within the inventory environment. For example, an alert may notify users that an inventory environment, or sub-environment, requires further attention. In some examples, the alerts are generated or displayed on a user interface component. The alerts may be audio, visual, a combination of both audio and visual, or any other suitable type of alert.

Aspects of the disclosure further enable increased user interaction performance and efficiency in managing the inventory environment because the machine learning component dynamically updates the existing model based on external and internal collected data, which also contributes to reduced error rates and faster processing. Automatic alerts, notifications, and/or recommendations are dynamically generated as new data is obtained via network communication, which also contributes to increased inventory environment management efficiency.

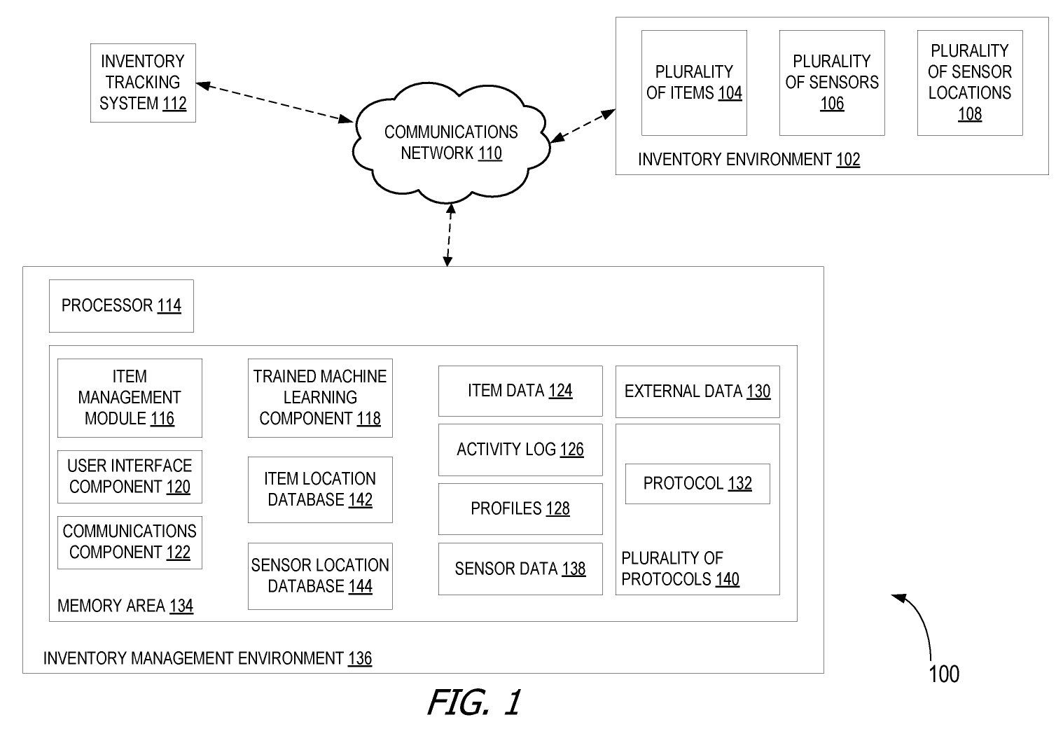

Referring again to FIG. 1, an exemplary block diagram illustrating a system for determining item viability based upon detected profiles. In the example of FIG. 1, the system 100 includes an inventory environment 102, an inventory tracking system 112, and an inventory management environment 136 all communicatively connected via a communications network 110.

In the example of FIG. 1, the inventory environment 102 includes a plurality of items 104, a plurality of sensors 106, and a plurality of sensor locations 108. The inventory environment 102 is, in some examples, a retail environment. As an example, inventory environment 102 may include a shelving system, produce display, cold storage, end cap, or any other location of sub-environment where items are accessible to consumers. In other examples, such as unmanned inventory fulfillment environments, inventory environment 102 may further include a plurality of storage locations where items are accessible to order fulfillment mechanisms of the environment, for example. The inventory environment 102 is not limited to retail environments, and may include other embodiments such as distribution centers, storage or resource centers, or any other location where items are accessible to multiple users.

The plurality of sensors 106 includes one or more sensors for detecting data corresponding to inventory environment 102. In one illustrative embodiment, plurality of sensors 106 may be sensors capable of detecting and capturing acoustic data. In some examples, acoustic sensors may passively receive sound and transmit sensor data, including sound data, to the inventory management environment 136. In other examples, acoustic sensors may actively monitor for sound data from the inventory environment 102. In these examples, the plurality of sensors 106 may detect and/or capture sounds generated as items are moved within the inventory environment 102 as part of sensor data 138 generated by the plurality of sensors 106. The sensor data 138 is transmitted via the communications network 110 for further analysis at the inventory management environment 136. In other examples, the plurality of sensors 106, individually or in a coordinated manner, actively emit sound waves or sonar to ping the inventory environment 102 to determine the location and/or status of various items in the plurality of items 104 using reflected sound waves and triangulation. The collected sounds recorded by the plurality of sensors 106, described herein as sound data, may be aggregated with other information to create sensor data 138. The sensor data 138 may also include other information, such as individual sensor identifiers associated with each of the individual sensors of the plurality of sensors 106. As an example, each of the plurality of sensors 106 may be assigned a unique identifier such as a universally unique identifier (UUID). In other examples, individual sensors of the plurality of sensors 106 may be associated with an individual location identifier corresponding to the inventory environment 102. Each of the plurality of sensors 106 may associate a timestamp with the detected or captured data when generating the sensor data 138. Among other operations, the timestamps may enable detected data transmitted from multiple sensors in the plurality of sensors 106 to be correlated based upon time of recording.

Each sensor in the plurality of sensors is associated with one of a plurality of sensor locations 108. The plurality of sensor locations 108 are identified, assigned, tracked, recorded, or otherwise stored or managed on the memory area 134 of the inventory management environment 136. Each sensor is associated with one of the plurality of sensor locations 108. Any location information related to items may be established relative to the plurality of sensor locations 108, because the plurality of sensors 106 are fixed, while the plurality of items 104 are mobile, in some examples.

The inventory environment 102 is communicatively connected to the inventory management environment 136 via the communications network 110. In the example of FIG. 1, the inventory management environment 136 may be implemented on a computing device and configured to determine item viability based upon detected data received from a plurality of sensors in an inventory environment via a communication network. In some examples the detected data includes acoustic data, such as captured and/or recorded sound data for example. In other examples the detected data may include weight data, measurement data, or any other suitable data detected by a sensor, such as a tactile, movement data, biometric data, or temperature data. The inventory management environment 136 includes a processor 114 and a memory area 134. Memory area 134 may include applications that may be executed by processor 114, such as an item management module 116, a user interface component 120, a trained machine learning component 118, and a communications component 122. Memory area 134 may also store data, such as item data 124, activity log 126, profiles 128, external data 130, sensor data 138, and a plurality of protocols 140, which includes individual protocol 132.

Item data 124 may include information associated with a plurality of individual items, such as, without limitation, an item identifier, item description, item weight, item size/dimensions, item stock-keeping unit (SKU), or any other item-specific information which may be used to identify a specific item, detect movement of the specific item, correlate any detected data with stored data profiles corresponding to specific individual items, and so forth. Profiles 128 includes a plurality of individual data profiles that may be used by item management module 116 to determine the identity of an item and/or the movement of an item by comparing detected data against profiles 128 to determine if a match is detected. In some examples, profiles 128 may include a plurality of acoustic profiles associated with a plurality of items or item types. In other examples, profiles 128 may include a plurality of weight profiles associated with a plurality of items or item types, or any other profile data that correlates an item with an action. Sensor data 138 may include detected data, which may be compared against profiles 128 to identify matching characteristics between the detected data and the stored profiles. For example, sensor data 138 may include detected acoustic data, which may reflect the sound of items moving within inventory environment 102, while profiles 128 may include one or more individual sound profiles associated with individual items and individual types of actions associated with those items.

In one illustrative example, a stored profile in profiles 128 may include acoustic data related to item packaging being gripped, by a hand or instrument, as well as corresponding item data. In this example, item management module 116 may compare detected acoustic data to the stored profile and detect a match between the acoustic data of the sensor data and the acoustic data of the stored profile. Item management module 116 may use the other data in the stored profile to identify the item associated with the sensor data, and correlate a protocol to the identified item and sensor data. In this way, item management module 116 may detect movement of a specific item within an inventory environment, identify the item, and assign a protocol or initiate an action or command based on the detection and identification to automatically manage inventory items.

In some examples, item data 124 further includes information such as transaction volume for individual items, valuation of the individual items, transaction information corresponding to the individual items, time, seasonality associated with the individual items, and so forth. Information included within item data 124 may be available in a database located in the inventory management environment 136, or available through an external source via the communications network 110 for processing along with market data to generate item data 124. The output generated by the item management module 116 may be provided to a client-side application. As an example, generated output may include information such as valuation, transaction information, and market data, which may be aggregated with the information synthesized by the described method and system in order to forecast profits, predict losses attributable to the individual items identified as undesirable, analyze individual item use trends, and so forth. The information included in the generated output of item management module 116 is provided, in some examples, as a report to a user, administrator, or a process for evaluation and may impact supply chain decisions, inventory forecasts, and so forth.

Activity log 126 includes logged information corresponding to activities within inventory environment 102, such as, for example, without limitation, stocking or shelving of items, cleaning or maintenance, personnel tracking, and the like, and may incorporate data from inventory tracking system 112 regarding item transactions associated with plurality of items 104, or other information regarding the plurality of items 104. The external data 130 includes any data from any other source which is utilized by the item management module 116. In some examples, external data 130 is retrieved from external databases (not illustrated), such as databases reflecting valuation, availability, or other criteria which influence market forces applying to plurality of items 104.

The item management module 116 may receive the sensor data 138 from plurality of sensors 106 and process the sensor data 138 to determine whether to assign a protocol from the plurality of protocols 140 to execute based upon the sensor data 138. In some examples, such as with sound data, the item management module 116 may triangulate the detected sound data from at least three sensors of the plurality of sensors 106 to identify a location of an item within inventory environment 102 and/or among the plurality of items 104 corresponding to a source of the detected sound data. In other examples, specific location identifiers associated with individual sensors may indicate a location of an item within inventory environment 102 and/or among plurality of items 104. The item management module 116 identifies a type of item associated with the detected data in part based upon the identified location of the detected data. Item locations within inventory environment 102 may be identified or tracked in a number of alternative methods. In some examples, an item location database 142 may include the locations of each item that is associated with the inventory environment 102. In this example, the item location database 142 may be cross-checked with a sensor location database 144, which maintains the locations of the plurality of sensors 108 which are associated with the inventory environment 102. In another example, inventory management environment 136 may maintain a table of the plurality of sensor locations 108 associated with a plurality of item locations within inventory environment 102. In still other examples, the sensor data 138 may include information regarding the location of the sensor transmitting sensor data 138 as well as corresponding stored item data associated with the sensor when implemented at the sensor location. In yet another example, the item management module 116 determines the location of a sensor by performing a lookup of the sensor in a table, database, matrix, and so on, using the sensor ID which is transmitted as part of the sensor data 138. In this example, the location of the sensor identified at lookup is correlated to a location of an item or group of items.

The item management module 116 attempts to identify a type of item associated with the detected data using the plurality of stored profiles 128 corresponding to an identified plurality of candidate items. In some examples, a trained machine learning component 118 may aid in associating the detected data with the plurality of candidate items. The trained machine learning component 118 is trained using training profile pairs. The training profile pair includes at least one identified profile and a corresponding item identifier. While the training profile pair is the minimum required to train the trained machine learning component 118, other data improves the model and hastens the process of training the trained machine learning component 118. The trained machine learning component 118 also accesses, in some examples, item data 124, activity logs 126, external data 130, plurality of protocols 140 and sensor data 138. In some examples the trained machine learning component 118 accesses other databases or sources of information (not illustrated) via the communications network 110. As an example, data from the inventory tracking system 112, or the database of a distributer, manufacturer, etc. is utilized along with the data stored in the memory area 134 in order to improve the training of the trained machine learning component 118. The data is used to weight the model relied upon by the trained machine learning component 118. As an example, data indicating large quantities of a specific item shipped from the distributor and placed in the inventory environment 102 may indicate high turnover or transactions for that item. In this example, the model is biased towards inferring that sensor data 138 matches a profile corresponding to an item with high turnover, where there may be two or more possible matches in stored profiles, for example. The model may be updated to reflect the higher probability based on the data retrieved from the external database.

The trained machine learning component 118 identifies a type of item associated with the detected data by pushing the detected data through the trained machine learning component. Previously identified sensor data is leveraged to validate the model developed by the trained machine learning component 118, while unidentified sensor data is used to continue training the trained machine learning component 118. External data 130 (e.g., information from distributors, information from the inventory tracking system 112, and so forth) are relied upon to improve the model, and update associated plurality of protocols 140, in some examples, by a user, administrator, or other external operator. In some examples, the trained machine learning component 118 is trained using identified sensor profiles, including associated tolerance thresholds for individual identified sensor profiles corresponding to individual items. In other words, for example, a baseline detected acoustic data may be recorded and associated with an item and a corresponding action as a stored profile for that item/action combination. As the same action is performed repeatedly on the same item, slightly different acoustic data is detected, resulting in slightly different profiles, for example. The stored profiles for the same item/action combination may be compared to establish tolerances thresholds, or outer limits for the stored profiles identified for that item/action combination. Those tolerance thresholds may be used to extrapolate tolerance thresholds for other profiles applicable to other item/action combinations. The tolerance thresholds are adjusted as additional data, including sensor data, is pushed through the trained machine learning component 118.

Not all detected data corresponds to stored profiles 128. In some examples, the trained machine learning component 118 receives or identifies detected data as “unidentified detected data” in response to a determination that the detected data does not correspond to any of the plurality of stored profiles 128. Upon determining that the detected data is unidentified, the trained machine learning component 118 attempts to evaluate the detected data and extrapolate upon its significance. To do so, the trained machine learning component 118 may obtain or access an activity log 126 associated with the location corresponding to at least one sensor of the plurality of sensors 106, and associate the unidentified sensor data with an individual activity based on a first timestamp associated with the unidentified sensor data and a second timestamp associated with the individual activity from the activity log.

In some examples the first and second timestamp are correlated based upon a predetermined time interval between the timestamps. As an example, the activity occurring at the second timestamp may be associated with the unidentified sensor data occurring at the first time stamp if they occur within a threshold of the predetermined time interval. This window of time may be adjustable, and may be updated by trained machine learning component 118 as new data is available.

Based upon the determination of the type of item, the item management module 116 may execute a corresponding protocol 132 stored upon the memory area 134. In some examples, further recommendations are issued, corresponding to the executed protocol 132.

The identified protocol 132, chosen from the plurality of protocols 140, instructs the item management module 116 to carry out various instructions depending on the type of item and identified profile. As an example, the protocol 132 might instruct the item management module 116 to transmit an alert via the communication network 110 to a user interface, or display an alert on the user interface component 120.

The protocol 132 might instruct the item management module 116 to record item activity for further evaluation by the trained machine learning component 118. As an example, the trained machine learning component 118 is instructed by the protocol 132 to adjust its model in order to reduce false positives and/or false negatives. Any information may be incorporated into the model to improve the operation of the trained machine learning component 118. In other examples, the protocol 132 instructs the item management module 116 to automatically request further item distribution (e.g. request an additional shipment or replenishment of the inventory environment 102), notify a manufacturer of problems, notify an associate of problems, and so on.

Additionally, the item management module 116 may receive transaction data associated with an item from an item tracking system 112, such as a point of sale system, via the communication network 110. The item management module 116 correlates the transaction data with the detected data to generate a report. As an example, the report may be a correlation of data transmitted by the item tracking system 112 and the sensor data 138. In other examples, an analysis is performed to generate the report that provides information regarding detected data, identified items, and associated detected movement and/or protocols. The report, in some examples, identifies trends associated with individual items, tracks metrics or statistics related to item inventory, and so forth. This report is communicated in some examples via the communications network 110, stored in the memory area 134 for later access, or displayed on the user interface component 120. In some examples the report is provided to the trained machine learning component 118. Where the report is provided to the trained machine learning component 118, the trained machine learning component 118 is updated using factors from the report. As an example, if the report includes information regarding item consumption relating to an identified time of day, then the model maintained by the machine learning component 118 is weighted to bias it towards predicting that a detected event relates to that item if it occurs during the identified time of day. As an example, if ninety percent of the purchases of an item occur after five in the afternoon, then the model operated by the machine learning component 118 may be biased to reflect this trend.

The inventory management environment 136 may be implemented at least in part on a computing device, which represents any device executing instructions (e.g., as application programs, operating system functionality, or both) to implement the operations and functionality as described herein. The computing device may include a mobile computing device or any other portable device. In some examples, the mobile computing device includes a mobile telephone, laptop, tablet, computing pad, netbook, gaming device, and/or portable media player. The computing device may also include less portable devices such as desktop personal computers, kiosks, tabletop devices, industrial control devices, wireless charging stations, and electric automobile charging stations. Additionally, the computing device may represent a group of processing units or other computing devices.

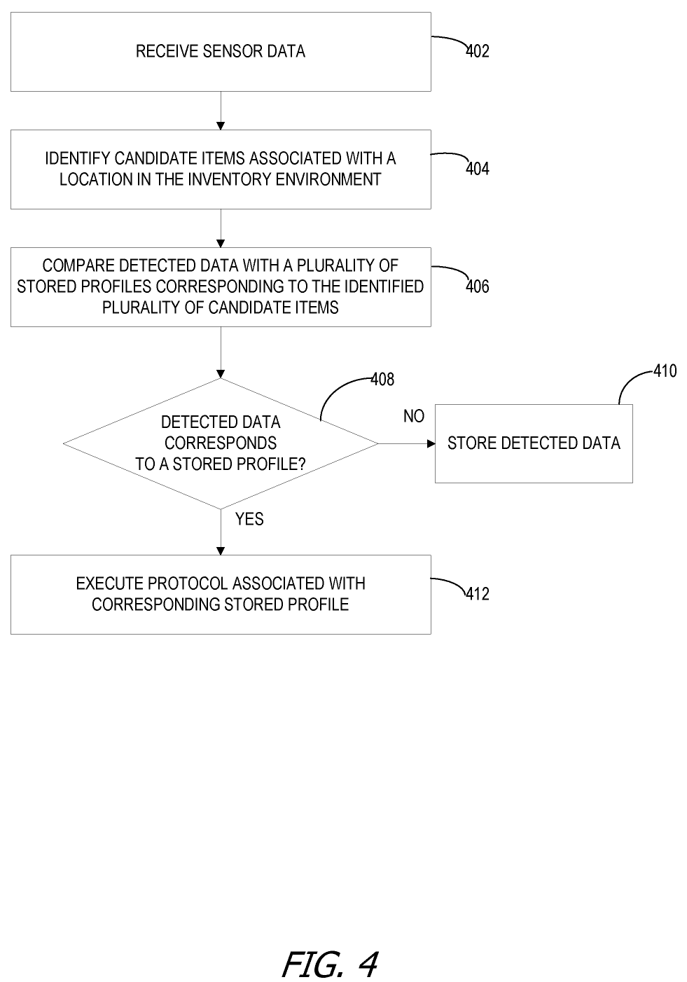

In some examples, the computing device has at least one processor 114, a memory area 134, and at least one user interface component 120. The processor 114 includes any quantity of processing units, and is programmed to execute computer-executable instructions for implementing aspects of the disclosure. The instructions may be performed by the processor 114 or by multiple processors within the inventory management environment 136, or performed by a processor external to the computing device. In some examples, the processor 114 is programmed to execute instructions such as those illustrated in the figures (e.g., FIGS. 4, 5, and 6).

In some examples, the processor 114 represents an implementation of analog techniques to perform the operations described herein. For example, the operations may be performed by an analog computing device and/or a digital computing device.

The computing device further has one or more computer readable media such as the memory area 134. The memory area 134 includes any quantity of media associated with or accessible by the computing device. The memory area 134 may be internal to the computing device (as shown in FIG. 1), external to the computing device (not shown), or both (not shown). In some examples, the memory area 134 includes read-only memory and/or memory wired into an analog computing device.

The memory area further stores one or more computer-executable components. Exemplary components include a user interface component 120, communications component 122, and trained machine learning component 118. The user interface component 120, when executed by the processor 114 of the inventory management environment 136, causes the processor 114 to perform operations, such as displaying alerts to a user. The communications component 122 when executed by the processor 114 of the inventory management environment 136, causes the processor 114 to perform operations such as receiving data, such as profiles 128, for example.

In some examples, the user interface component includes a graphics card for displaying data to the user and receiving data from the user. The user interface component may also include computer-executable instructions (e.g., a driver) for operating the graphics card. Further, the user interface component may include a display (e.g., a touch screen display or natural user interface) and/or computer-executable instructions (e.g., a driver) for operating the display. The user interface component may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular way. In another example, the user may input commands or manipulate data by providing a gesture detectable by the user interface component, such as a touch or tap of a touch screen display or natural user interface.

In some examples, a user may interact with the system of computing device 102 via communications network 110 using an interface. Interface may be a user interface component of another computing device communicatively coupled to communication network 110, for example (not illustrated). In some examples, interface may provide an interface for receiving user input and displaying content to the user, while item management operations are performed on the backend at the inventory management environment 136.

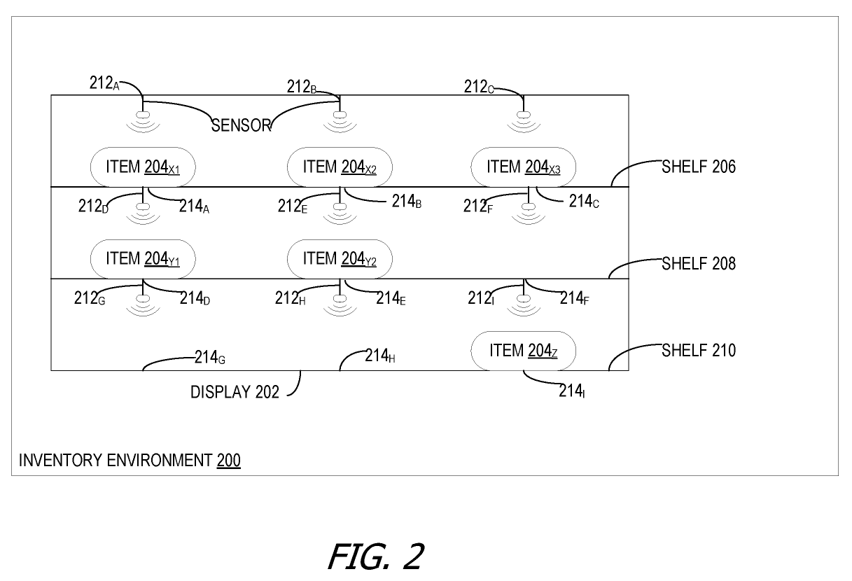

FIG. 2 is an exemplary inventory environment illustrating a possible configuration of sensors and items. Inventory environment 200 may be an illustrative example of one implementation of inventory environment 102 in FIG. 1. In some examples, the inventory environment 200 may be a store, a distribution center, a warehouse, or any other location which stores items or goods. Inventory environment 200 may include a number of sub-environments, such as individual displays, shelving units, bins, sections, sub-sections, areas, aisles, or other individual locations associated with items.

In the example of FIG. 2, inventory environment 200 includes display 202, which holds an assortment of items arranged on shelves. In this example, more than one type of item may be stored at display 202. However, in other examples, display 202 may include items of a same item type, or multiple items types in different categories of item types. For example, a category of item types may include eggs, while item types within the category of eggs may include brand A eggs and brand B eggs, or some other item type differentiation. In this illustrative example, a display may be dedicated to a category, such as eggs, including one or more item types, such as one or more different brands, sizes, or units per packaging of eggs.

In the example of FIG. 2, three types of items of a same item category may be stored: 204_{X}, 204_{Y}, and 204_{Z}. For purposes of clarity in illustration, where more than one of each item type are stored, they are indicated with a numbered subscript. As an example, there are three of item 204_{X}: 20_{4X1}, 204_{X2}, and 204_{X3}. Similarly, in FIG. 2 there are two of item 204_{Y} (204_{Y1} and 204_{Y2}), and one of item 204_{Z}. Display 202 includes a number of shelves, illustrated here as shelf 206, shelf 208, and shelf 210. The items 204 are stored or located at individual shelves of display 202, as depicted here with item 204_{X1}, 204_{X2}, and 204_{X3} located at shelf 206, item 204_{Y1} and 204_{Y2} located at shelf 208, and item 204_{Z} located at shelf 210.

Inventory environment 200 further includes a plurality of sensors 212_{A} through 212_{I} that may be located at discreet locations of display 202 and/or shelves 206, 208, and 210, such as affixed or otherwise associated with the bottom of a shelf above a display area, the bottom of a shelf under a display area, a side of a display area, or a surrounding structure adjacent to a display area, for example. Individual sensors may be associated with individual locations of display 202 and/or shelves 206, 208, and 210, for example. Here, illustrated display locations 214_{A} through 214_{I} may be identified by item management module 116 in FIG. 1 using detected data from one or more of sensors 212_{A}- 212_{I}, by correlating stored item location data, display and/or shelving configuration data, and/or other item data with detected sensor data, for example, to identify a discreet location of an item, such as item 204_{X1} at location 214_{A} of shelf 206 within display 202. In this way, the inventory management environment may not only identify a type of item and action associated with detected sensor data, but may also identify a specific location corresponding to the item and action, such that detected data may be used to generate an alert that provides specific information regarding the item and the location within inventory environment 200.

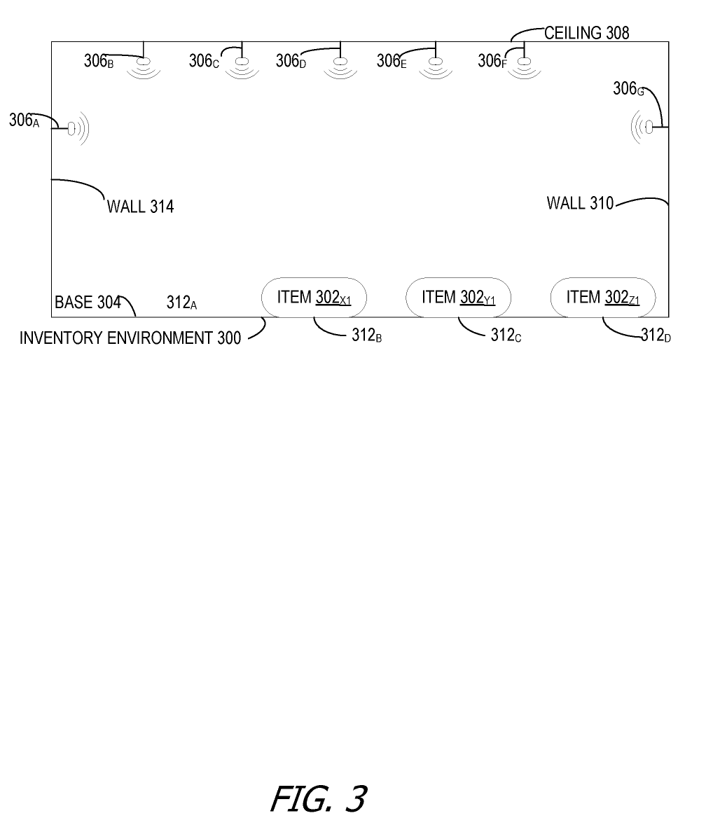

In the example of FIG. 2, the locations of items 204_{X1}, 204_{X2}, and 204_{X3} within display 202 correspond to display locations 212_{A}-212_{c}, which may be associated with sensors 212_{A}-212c. Although the illustrative example provides a sensor at each display location (e.g., there is one sensor 212 associated with each display location 214), alternative embodiments are contemplated, such as where a sensor may be configured to detect data at a display area having a plurality of locations, and identifying a discreet location within the display area based at least in part using the detected sensor data. Alternatively, sensors 212 may be arrayed throughout the inventory environment 200, as further illustrated in FIG. 3. As an individual item, for example item 204_{X1} is moved from location 214_{A} to 214_{G} the detected data from the movement will be different than if item 204_{X1} were moved to a display or location within inventory environment 200 other than display 202.

In other examples, display 202 may be separated into discrete tracks, slots, aisles, or other segregated spaces capable of receiving items 202. In these examples, the sensors may be arrayed above the segregated spaces, and the plurality of sensor locations translated to a fixed location.

In another illustrative example, the sensors 212 may be weight sensors. Weight sensors may be used alone, or in tandem with a plurality of acoustic sensors that detect sensor data. The weight sensors may be, in some examples, underneath or incorporated into the shelves 206, 208, and 210, underneath or incorporated into the base of display 202, underneath or incorporated into the flooring of inventory environment 200, and so forth. In some examples weight sensors are correlated with individual bins, racks, holders, or any location which stores a discrete number of items. Where weight sensors are used, the weight sensors may also be associated with a plurality of sensor locations, and record detected data. Data recorded by weight sensors may include changes in weight data, which may be compared to stored weight profiles, which may be included in profiles 128 in FIG. 1, for example. All other external data 130, activity logs 126, and protocols 132 from the plurality of protocols 140 may be utilized in the same or substantially similar manner as those described above with regard to the illustrative implementation of acoustic sensors. Weight profiles reflect, in some examples, change which occur as one or more items are retrieved or replaced in the inventory environment 200.

FIG. 3 is an alternative exemplary inventory environment illustrating another possible configuration of sensors and items. FIG. 3 illustrates an inventory environment 300 which may be an open area, like an area of a retail store, rather than a contained display as depicted in FIG. 2. In the example inventory environment 300 of FIG. 3, the items of three different types, 302_{X1}, 302_{Y1}, and 302_{Z1} are arrayed in an open space on a base 304 such as a floor or a single-tiered display (e.g. a table, a single level display, a storage unit, etc.). The sensors 306_{A} through 306_{G} are attached to the ceiling 308, wall 310, and wall 314 of the inventory environment 300. Although not illustrated, the sensors may also be attached to the base 304 or floor of the inventory environment 300. While the example of FIG. 3 includes static inventory locations 312_{A} through 312_{D}, those locations do not correlate directly to the locations of sensors 306_{A} through 306_{G}.

In the example of FIG. 3, the plurality of sensor locations do not necessarily correspond to the location of specific inventory locations. Instead the plurality of sensors are arrayed in this illustrative example to provide an efficient coverage of the inventory environment 300.

FIG. 4 is an exemplary flow chart illustrating operation of the system to evaluate a detected profile for an item and execute an associated protocol in order to perform inventory analysis and management. The exemplary operations presented in FIG. 4 may be performed by one or more components described in FIG. 1, for example the item management module 116 operating in the inventory management environment 136.

The process receives sensor data from at least one sensor of a plurality of sensors at operation 402. The sensor data may include data detected by one or more sensors, such as acoustic data or weight data, for example, transmitted via the communications network 110, and accessed, obtained, or otherwise received by the inventory management environment 136 in FIG. 1, for example. The sensor data is received by the communications component 122, in some examples, and stored on the memory 134 of the inventory management environment 136 in FIG. 1. The sensor data may be utilized by a component of the inventory management environment 136, such as the item management module 116, to identify a type of item associated with the detected data and determine an action or other information associated with that item in order to identify a potential protocol that may be activated in response to the received sensor data. The sensor data may include, in some examples, without limitation, the specific sensor location, out of the plurality of sensor locations associated with each sensor, a timestamp corresponding to the time the sensor data was recorded, a sensor identifier corresponding to the particular sensor which recorded and/or detected the sensor data, and the detected data associated with the sensor data.

At operation 404, the process identifies a plurality of candidate items associated with a location in the inventory environment. The process uses various data to identify candidate items. As an example, the item management module 116 may use item location maps or inventory records which may be stored upon the memory area 134 to identify candidate items corresponding to the received sensor data. The item management module 116 may identify which of the plurality of sensor locations corresponds to a sensor associated with the received sensor data based on the sensor identifier of the received sensor data. The item management module 116 may use this location information and item data obtained during analysis to identify one or more candidate items associated with the sensor data. The item data may include, for example, inventory information about the inventory environment, possible candidate items typically available in that location of the inventory environment, statistics regarding rate of turnover of items at that location or of that type, and so forth.

The process compares the detected data from the received sensor data to a plurality of stored profiles corresponding to the identified plurality of candidate items at operation 406. Each candidate item may have more than one associated stored profile. As an example, the profiles 128 associated with the candidate item could include one or more stored profiles associated with actions, such as removing the candidate item, replacing the candidate item, sliding the candidate item, gripping the candidate item, and so forth.

The process determines whether the detected data corresponds to at least one of the stored profiles in the plurality of stored profiles at operation 408. If the process determines that the detected data does not correspond to any of the stored profiles, the process stores the detected data at operation 410, and optionally may mark the stored data for further evaluation. If the process determines that the detected data corresponds to at least one stored profile, the process executes a protocol associated with the corresponding stored profile at operation 412, with the process terminating thereafter.

The protocol, in some examples, may include instructions executed by the item management module 116 to create alerts, notifications, or transmit information to external components. As an example, if the detected data corresponds to a stored profile, which is associated with the candidate item being removed then replaced, an alert is generated to notify a user that the inventory environment potentially needs attention (e.g., the item should be removed or inspected as it may be undesirable). As an alternative example, if the detected data corresponds to a stored profile, which is associated with the item being removed, with no subsequent data that the item is replaced, and a threshold inventory level has been reached with respect to data indicating removal of that item, then an alert may be generated that the inventory environment should be replenished with regard to that particular item.

In some examples, the protocol executed by the item management module depends on identifying the type of item. In this example, the item management module 116 identifies the type of item associated with the detected data, based at least in part on detected sensor data, item data, such as product location information stored about the item compared to the stored sensor location or the location that is associated with the item, and other information such as the external data, in order to identify which type of item corresponds to the detected data. Upon determining the type of item, the item management module 116 executes protocol 132 which is tailored to that identified type of item, for example. As an example, in a retail environment, if the item is identified as egg cartons, and the profile matched by the item management module indicates removal and replacement of the egg carton a threshold number of times within a given time period, then the associated protocol 132 may include a notification or alert that prompts an associate to inspect and/or remove the unwanted egg cartons based upon the presumption that they contain broken eggs. In this example, the protocol may indicate that a certain number of items or threshold level of actions associated with that item be detected as undesirable before issuing the alert to the associate. In an alternative example, if the protocol matched to the detected data indicates removal of the egg carton, and external data indicates correlating transactions of the egg carton, the protocol associated with the profile for that item type may indicate that a notification for inventory replenishment of that item type be generated and transmitted to a system or user in order to automatically replenish the items in the inventory environment.

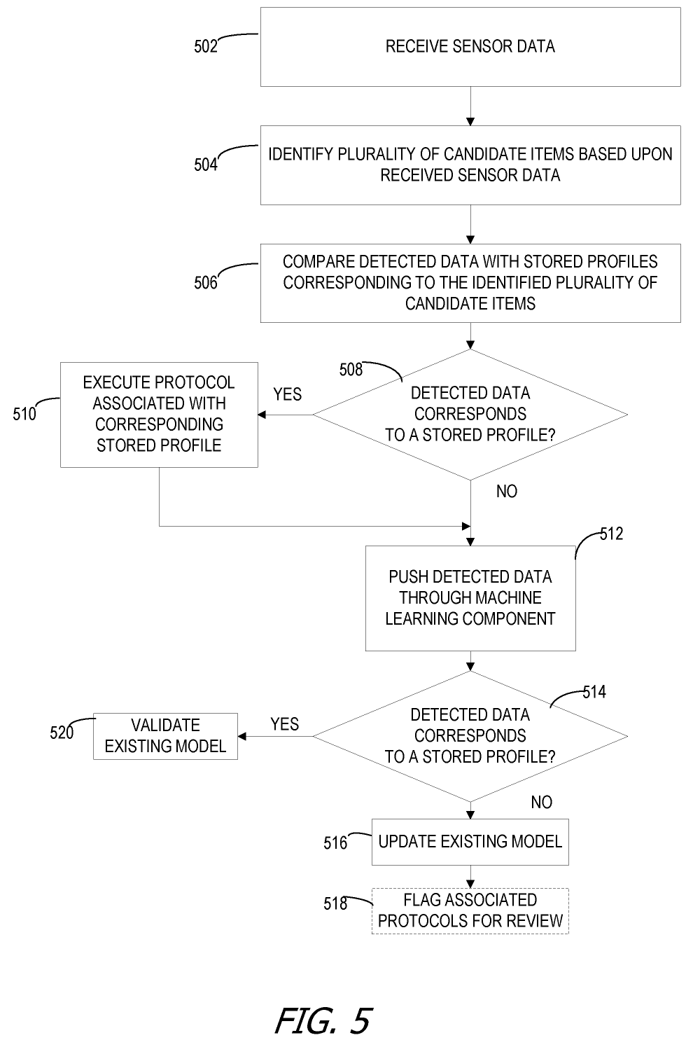

FIG. 5 is an exemplary flow chart illustrating operation of a machine learning component of the system to evaluate detected profiles and update the machine learning model. The exemplary operations presented in FIG. 5 may be performed by one or more components described in FIG. 1, for example the item management module 116 operating in the inventory management environment 136.

The process receives sensor data from at least one sensor of a plurality of sensors at operation 502. At operation 504, the process identifies a plurality of candidate items based upon the received sensor data. Identification of candidate items may be based in part on data associated with item location in the inventory environment. The process (e.g. the item management module) then compares the detected data from the received sensor data to a plurality of stored profiles corresponding to the identified plurality of candidate items at operation 506. The process determines whether the detected data corresponds to at least one of the stored profiles in the plurality of stored profiles at operation 508. If the detected data corresponds to at least one stored profile, the process executes a protocol associated with the corresponding stored profile at operation 510.

If at operation 508 the detected data does not correspond to at least one stored profile, then the process pushes the detected data through the machine learning component. The machine learning component, such as trained machine learning component 118 in FIG. 1, may be trained using known profiles and known item data, or training pairs of items and actions, for example. Additionally, if the detected data does correspond to a stored profile and the corresponding protocol is executed at operation 510, the detected data may still be pushed through the machine learning component at operation 512. At operation 512, in addition to the detected data, the machine learning component may obtain additional information, such as data from the activity log, the protocols, sources of external data, and the profiles, which is pushed through the learning component during evaluation of the detected data.

At operation 514, if the detected data was determined to have corresponded to a stored profile at operation 508, then the existing model operated by the trained machine learning component is validated at operation 520. Otherwise, the existing model is updated at operation 516. Where the existing model is updated, in some circumstances the protocols associated with the model or with the profiles may also be updated. In those examples, the protocols are optionally flagged for review at operation 518.

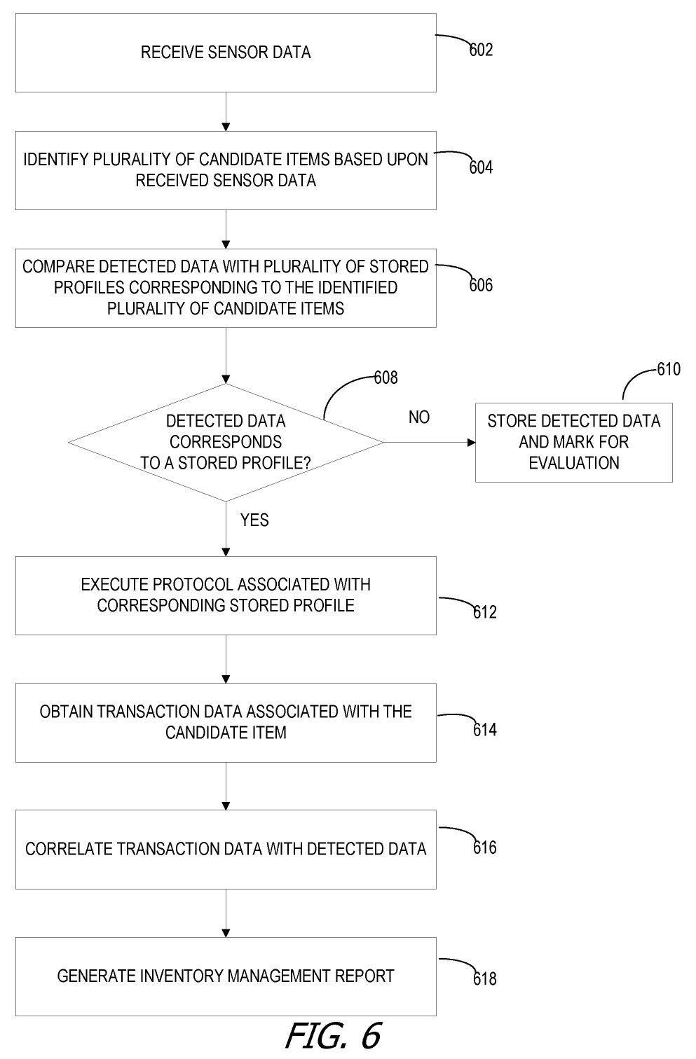

FIG. 6 is an exemplary flow chart illustrating operation of the system to correlate external data, such as reports from an item tracking system, with the detected profiles and to create reports based upon the correlated data. The exemplary operations presented in FIG. 6 may be performed by one or more components described in FIG. 1, for example the item management module 116 operating in the inventory management environment 136.

The process receives sensor data from at least one sensor of a plurality of sensors at operation 602. At operation 604, the process identifies a plurality of candidate items based upon the received sensor data. The candidate items may be identified at least in part using item location data, such as information about inventory items associated with a location in the inventory environment. The process (e.g. the item management module) then compares the detected data from the received sensor data to a plurality of stored profiles corresponding to the identified plurality of candidate items at operation 606. The process determines whether the detected data corresponds to at least one of the stored profiles in the plurality of stored profiles at operation 608. If the detected data does not correspond to a stored profile, the detected data is stored and marked for evaluation at operation 610.

If the detected data corresponds to at least one stored profile, the process executes a protocol associated with the corresponding stored profile at operation 612. The process obtains transaction data associated with the candidate item at operation 614. The candidate item is identified, or narrowed down from the plurality of candidate items, based at least in part by matching the profile to the detected data, such that information in the corresponding profile identifies the candidate item associated with the detected data. In some examples the transaction data is aggregated by the inventory tracking system 112 and transmitted through the communications network 110 to the item management module 116. The inventory tracking system 112 is, in some examples, a system associated with cash registers, point of sale devices, or other checkout devices in a retail environment. Alternatively, the inventory tracking system 112 is associated with a source such as a distribution center.

At operation 616 the process correlates the transaction data with the detected data. As an example, if a transaction of an item is recorded by the inventory tracking system 112, and the detected data is matched with a profile indicating removal of that item from a display or other location, then the detected data is associated with the removal of the item form the inventory environment 102. If no transaction is recorded proximate to the detected data, then the detected data is associated, in some examples, with the removal and replacement of the item. Based on any correlations made at operation 616, an inventory management report is generated at operation 618. The report is used, in some examples, by an administrator to update the trained machine learning component 118. In other examples the report is used to manage the items 202 or update the protocols 132. In still other examples, the report may be configured as an alert to an associate or other personnel, prompting a specific task or action to be taken as a result of the report. In this example, the specific task may be used to feed back into the system through the activity logs, and used as part of the machine learning process to confirm the detection and correlated protocol identified by the system.

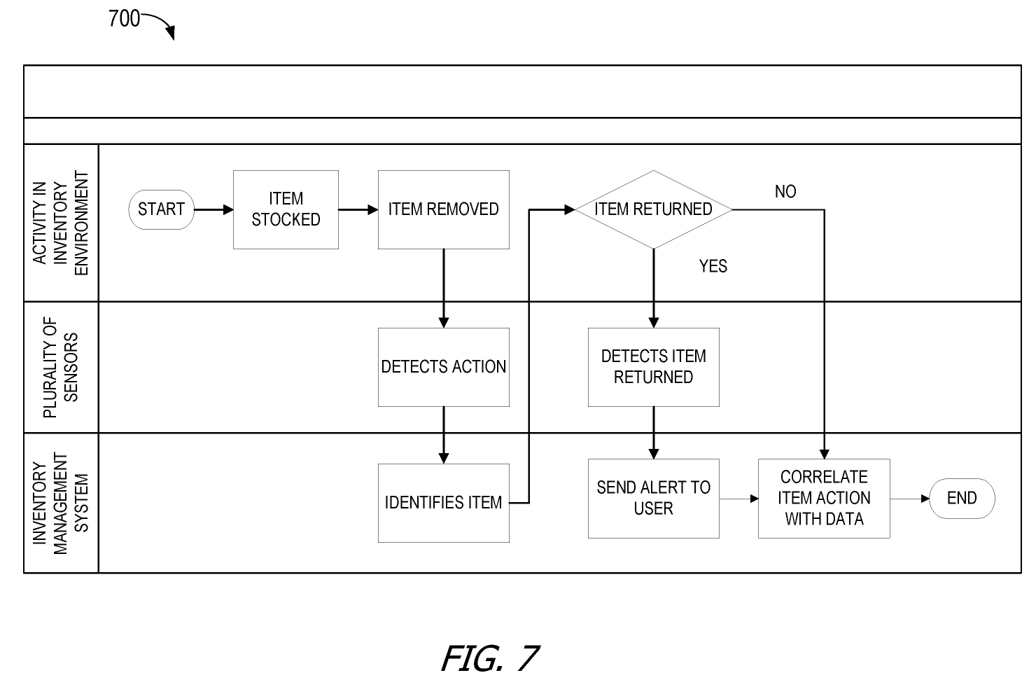

FIG. 7 is an exemplary data flow illustrating interactions between the activity in the inventory environment, data detected by the plurality of sensors, and the inventory management system. Inventory management environment 700 may be an illustrative example of inventory management environment 136 in FIG. 1.

As depicted in this illustrative data flow, the flow begins with activity in the inventory environment. In the illustrated data flow, an item or plurality of items are stocked in the inventory environment. As discussed above, examples of this operation include stocking displays in a retail environment, accruing inventory in a distribution center, managing supplies in an office environment, etc. Subsequently, an item is removed from the inventory environment which results in an action that may be detected by one or more of the plurality of sensors in the inventory environment. For example, an action may be a sound associated with moving or removing the item, or a redistribution of weight associated with removal and/or replacement of an item. The detected data is captured by at least one of the plurality of sensors, resulting in sensor data which includes the detected data. In this illustrative data flow, at least one of the plurality of sensors detects an action based on the item removal, which may be a sound or other detected data. The inventory management system receives the detected data from the sensor data transmitted by the at least one sensor and uses the sensor data to identify the item associated with the action detected by the sensor. If there is no detection within a threshold time period that the item is returned or replaced (no further proximate action that identifies the same item within the threshold time period), then the inventory management system, and more specifically the item management module, correlates the detected data, representing the action associated with the item, with other data. As an example, the item management module correlates data from the inventory tracking system which indicate information such as the sale of the item with the detected data and other sensor information gleaned from the sensor data, along with data in the activity log, the item data, and external data. If the item is detected as returned to the inventory environment, then the inventory management system sends an alert to a user, and subsequently correlates the action of that item with the available data. The user may be personnel associated with the inventory environment, or another process that receives the alert and takes action accordingly, for example.

### Additional Examples

In some examples, the operations illustrated in FIGS. 4, 5, and 6 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

Alternatively, or in addition to the other examples described herein, examples include any combination of the following:

receives the sensor data from at least three sensors of the plurality of sensors;

triangulates the detected data from the at least three sensors to identify a location corresponding to a source of the detected data;

wherein the item management module further identifies a type of item associated with the detected data using the plurality of stored profiles corresponding to the identified plurality of candidate items;

determines the protocol to execute based on identified type of item;

wherein the item management module further comprises a trained machine learning component trained using training profile pairs, a training profile pair comprising at least one identified profile and a corresponding item;

wherein the trained machine learning component identifies a type of item associated with the detected data by pushing the detected data through the trained machine learning component;

wherein the trained machine learning component is trained using identified profiles, including associated tolerance thresholds for individual identified profiles corresponding to individual items;

wherein the trained machine learning component receives the detected data as unidentified detected data in response to a determination that the detected data does not corresponds to any of the plurality of stored profiles and further identifies an activity log associated with the location corresponding to the at least one sensor;

associates the unidentified detected data with an individual activity based on a first timestamp associated with the unidentified detected data and a second timestamp associated with the individual activity from the activity log;

wherein the trained machine learning component generates a new protocol based upon an analysis of detected data which is not associated with any of the plurality of stored profiles;

wherein the protocol instructs the item management module to transmit an alert via the communication network;

wherein the item management module further receives transaction data associated with an item from an item tracking system via the communication network;

correlates the transaction data with the detected data to generate a report;

wherein the item tracking system is at least one of an inventory management system or a point of sale system;

wherein the item management module identifies the plurality of candidate items associated with the location corresponding to the at least one sensor based on at least one of an item location map or an item inventory record;

wherein the plurality of sensors further associates a timestamp with the detected data to generate the sensor data;

identifying a type of item associated with the detected data using the plurality of stored profiles corresponding to the identified plurality of candidate items;

determining the protocol to execute based on identified type of item;

identifying a type of item associated with the detected data by pushing the detected data through a trained machine learning component;

responsive to a determination that the detected data does not correspond to any of the plurality of stored profiles, identifying an activity log associated with the location corresponding to the at least one sensor;

associating the detected data with an individual activity based on the corresponding timestamp of the received sensor data and another timestamp associated with the individual activity from the activity log;

receiving transaction data associated with an item from an item tracking system via the communication network;

correlating the transaction data with the detected data to generate a report;

issuing a recommendation in accordance with the executed protocol.

### Exemplary Operating Environment

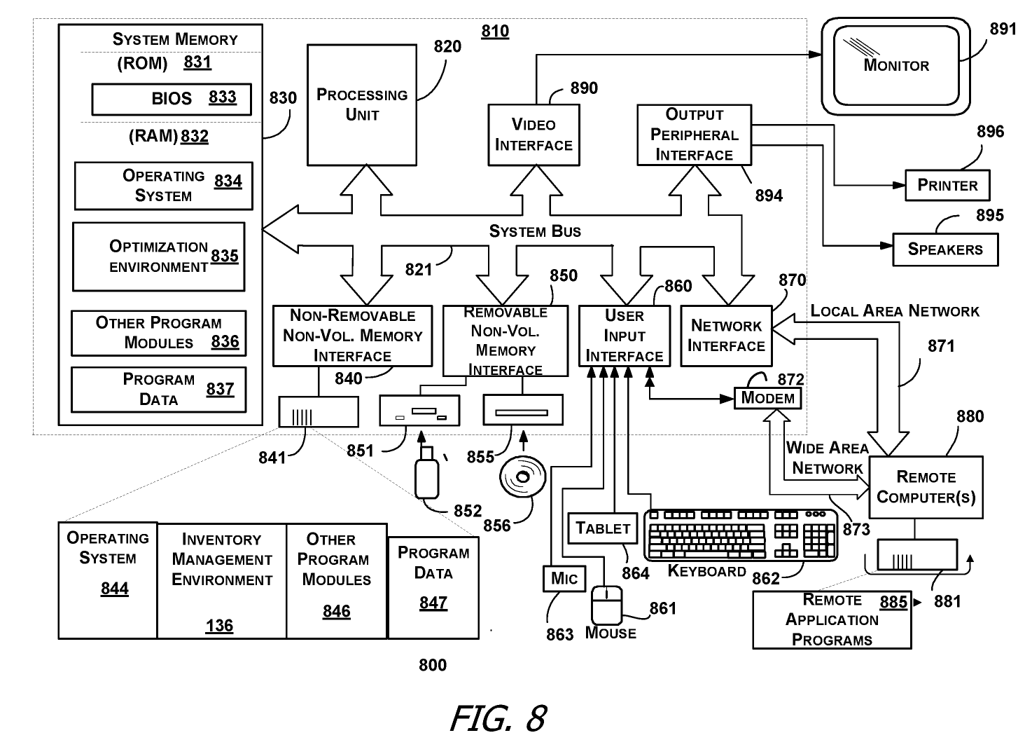

FIG. 8 illustrates an example of a suitable computing and networking environment 800 on which the examples of FIG. 1 may be implemented. The computing system environment 800 is only one example of a suitable computing environment and is not intended to suggest any limitation as to the scope of use or functionality of the disclosure. Neither should the computing environment 800 be interpreted as having any dependency or requirement relating to any one or combination of components illustrated in the exemplary operating environment 800.

The disclosure is operational with numerous other general purpose or special purpose computing system environments or configurations. Examples of well-known computing systems, environments, and/or configurations that may be suitable for use with the disclosure include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 8, an exemplary system for implementing various aspects of the disclosure may include a general purpose computing device in the form of a computer 810. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 810 typically includes a variety of computer-readable media. Computer-readable media may be any available media that may be accessed by the computer 810 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Memory 831 and 832 are examples of computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computer 810. Computer storage media does not, however, include propagated signals. Rather, computer storage media excludes propagated signals. Any such computer storage media may be part of computer 810.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs, such as optimization environment 835, other program modules 836 and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a universal serial bus (USB) port 851 that provides for reads from or writes to a removable, nonvolatile memory 852, and an optical disk drive 855 that reads from or writes to a removable, nonvolatile optical disk 856 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and USB port 851 and optical disk drive 855 are typically connected to the system bus 821 by a removable memory interface, such as interface 850.

The drives and their associated computer storage media, described above and illustrated in FIG. 8, provide storage of computer-readable instructions, data structures, program modules and other data for the computer 810. In FIG. 8, for example, hard disk drive 841 is illustrated as storing operating system 844, inventory management environment 136, other program modules 846 and program data 847 (such as the trained learning component 118, item data 124, and sensor data 138, as illustrated in FIG. 1). Note that these components may either be the same as or different from operating system 834, optimization environment 835, other program modules 836, and program data 837. Operating system 844, inventory management environment 136, other program modules 846, and program data 847 are given different numbers herein to illustrate that, at a minimum, they are different copies. A user may enter commands and information into the computer 810 through input devices such as a tablet, or electronic digitizer, 864, a microphone 863, a keyboard 862 and pointing device 861, commonly referred to as mouse, trackball or touch pad. Other input devices not shown in FIG. 8 may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. The monitor 891 may also be integrated with a touch-screen panel or the like. Note that the monitor and/or touch screen panel may be physically coupled to a housing in which the computing device 810 is incorporated, such as in a tablet-type personal computer. In addition, computers such as the computing device 810 may also include other peripheral output devices such as speakers 895 and printer 896, which may be connected through an output peripheral interface 894 or the like.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include one or more local area networks (LAN) 871 and one or more wide area networks (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860 or other appropriate mechanism. A wireless networking component such as comprising an interface and antenna may be coupled through a suitable device such as an access point or peer computer to a WAN or LAN. In a networked environment, program modules depicted relative to the computer 810, or portions thereof, may be stored in the remote memory storage device. By way of example, and not limitation, FIG. 8 illustrates remote application programs 885 as residing on memory device 881. It may be appreciated that the network connections shown are exemplary and other means of establishing a communications link between the computers may be used.

The examples illustrated and described herein as well as examples not specifically described herein but within the scope of aspects of the disclosure constitute an exemplary system and method for determining item viability based upon detected profiles as items are moved in an inventory environment. For example, the elements illustrated in FIG. 1, such as when encoded to perform the operations illustrated in FIGS. 4, 5, and 6 constitute exemplary means for receiving at least one sensor data containing detected data from one or more of a plurality of sensors, exemplary means for correlating the sensor data with known profiles, exemplary means for determining the action performed on an item based upon the correlation, and executing an appropriate protocol based upon the correlation.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for managing a plurality of items, the system comprising:
at least one processor;
a plurality of sensors that detect data and transmit sensor data to the at least one processor via a network, the sensor data including the detected data and individual sensor identifiers associated with individual sensors of the plurality of sensors; and
an item management module, implemented on the at least one processor, that:
receives the sensor data from at least one sensor of the plurality of sensors;
identifies a plurality of candidate items associated with a location corresponding to the at least one sensor based on an individual sensor identifier associated with the at least one sensor;
compares the detected data from the sensor data to a plurality of stored profiles corresponding to the identified plurality of candidate items;
determines whether the detected data corresponds to at least one stored profile in the plurality of stored profiles; and
responsive to a determination that the detected data corresponds to the at least one stored profile, executes a protocol associated with the at least one stored profile.

2. The system of claim 1, wherein the item management module further:
receives the sensor data from at least three sensors of the plurality of sensors; and
triangulates the detected data from the at least three sensors to identify a location corresponding to a source of the detected data.

3. The system of claim 1, wherein the item management module further:
identifies a type of item associated with the detected data using the plurality of stored profiles corresponding to the identified plurality of candidate items; and
determines the protocol to execute based on identified type of item.

4. The system of claim 1, wherein the item management module further comprises:
a trained machine learning component trained using training profile pairs, a training profile pair comprising at least one identified profile and a corresponding item.

5. The system of claim 4, wherein the trained machine learning component identifies a type of item associated with the detected data by pushing the detected data through the trained machine learning component.

6. The system of claim 4, wherein the trained machine learning component is trained using identified profiles, including associated tolerance thresholds for individual identified profiles corresponding to individual items.

7. The system of claim 4, wherein the trained machine learning component receives the detected data as unidentified detected data in response to a determination that the detected data does not corresponds to any of the plurality of stored profiles and further:
identifies an activity log associated with the location corresponding to the at least one sensor; and
associates the unidentified detected data with an individual activity based on a first timestamp associated with the unidentified detected data and a second timestamp associated with the individual activity from the activity log.

8. The system of claim 4, wherein the trained machine learning component generates a new protocol based upon an analysis of detected data which is not associated with any of the plurality of stored profiles.

9. The system of claim 1, wherein the protocol instructs the item management module to transmit an alert via the communication network.

10. The system of claim 1, wherein the item management module further:
receives transaction data associated with an item from an item tracking system via the communication network; and
correlates the transaction data with the detected data to generate a report.

11. The system of claim 10, wherein the item tracking system is at least one of an inventory management system or a point of sale system.

12. The system of claim 1, wherein the item management module identifies the plurality of candidate items associated with the location corresponding to the at least one sensor based on at least one of an item location map or an item inventory record.

13. The system of claim 1, wherein the plurality of sensors further associates a timestamp with the detected data to generate the sensor data.

14. A method for inventory analysis, comprising:
receiving sensor data from at least one sensor of a plurality of sensors, the sensor data including detected data, a corresponding timestamp, and a sensor identifier corresponding to the at least one sensor;
identifying a plurality of candidate items associated with a location corresponding to the at least one sensor based on the sensor identifier of the received sensor data;
comparing the detected data from the received sensor data to a plurality of stored profiles corresponding to the identified plurality of candidate items;
determining whether the detected data corresponds to at least one stored profile in the plurality of stored profiles; and
responsive to a determination that the detected data corresponds to the at least one stored profile, executing a protocol associated with the at least one stored profile.

15. The method of claim 14, further comprising:
identifying a type of item associated with the detected data using the plurality of stored profiles corresponding to the identified plurality of candidate items; and
determining the protocol to execute based on identified type of item.

16. The method of claim 14, further comprising:
identifying a type of item associated with the detected data by pushing the detected data through a trained machine learning component.

17. The method of claim 14, further comprising:
responsive to a determination that the detected data does not correspond to any of the plurality of stored profiles, identifying an activity log associated with the location corresponding to the at least one sensor; and
associating the detected data with an individual activity based on the corresponding timestamp of the received sensor data and another timestamp associated with the individual activity from the activity log.

18. The method of claim 14, further comprising:
receiving transaction data associated with an item from an item tracking system via the communication network; and
correlating the transaction data with the detected data to generate a report.

19. One or more computer storage devices having computer-executable instructions stored thereon for inventory management, which, on execution by a computer, cause the computer to perform operations comprising:
receiving sensor data from at least one sensor of a plurality of sensors, the sensor data including detected data, a corresponding timestamp, and a sensor identifier corresponding to the at least one sensor;
identifying a plurality of candidate items associated with a location corresponding to the at least one sensor based on the sensor identifier of the received sensor data;
comparing the detected data from the received sensor data to a plurality of stored profiles corresponding to the identified plurality of candidate items;
determining whether the detected data corresponds to at least one stored profile in the plurality of stored profiles; and
responsive to a determination that the detected data corresponds to the at least one stored profile, executing a protocol associated with the at least one stored profile.

20. The one or more computer storage devices of claim 19, further comprising:
issuing a recommendation in accordance with the executed protocol.
